(19) United States
(12) Patent Application Publication
(10) Pub. No.: US 2009/0198627 A1
(43) Pub. Date: Aug. 6, 2009

(54) Multi-Leveled Graphical Representation Business Listing and Investment Portfolio Evaluation Method

(76) Inventor: Robert Johnson, Wellesley, MA (US)

Correspondence Address: LAMBERT & ASSOCIATES, P.L.L.C., 92 STATE STREET, BOSTON, MA, 02109-2004, US

(21) Appl. No.: 12/023,121

(22) Filed: Jan. 31, 2008

(51) Int. Cl. G06Q 40/00

(52) U.S. Cl. 705/36 R

(57) ABSTRACT

A method of graphically representing and evaluating various business portfolios and listings. The method graphically depicts various user defined stages of use as “arrays” about a central pivot point, graphically depicts various user defined focus areas as “threads” about a central pivot point and graphically depicts various user defined listing capabilities as “fibers” created by segmenting threads. Information concerning these arrays, threads and fibers is conveyed to users by the presence or absence of various colors, shades or patterns within the various arrays, threads and fibers. Also, additional information about the threads and arrays may be conveyed to users by introducing movement of these arrays and threads.

### FIELD OF THE INVENTION

The present invention relates generally to methods that analyze, evaluate and compare the effectiveness of an investment portfolio and with more particularity to methods that utilize assessment algorithms that are tied to a graphical portfolio representation. This invention also generally relates to computer software that may generate and display output from the above mentioned algorithms.

### REFERENCES

In general within the art, descriptions of methods of analyzing, evaluating and comparing investment portfolios with algorithms and graphical representations are found in U.S. Pat. No. 4,742,457 set forth by Leon et al.; and U.S. Pat. No. 6,338,047 by Wallman; and U.S. Pat. No. 7,020,625 set forth by Tiley et al.; and U.S. Pat. No. 7,0857,038 by Tarrant; and U.S. Pat. No. 7,107,229 by Sullivan; and U.S. Pat. No. 7,120,600 by Tarbox et al.; and U.S. Pat. No. 7,213,002 by Cohen.

### BACKGROUND OF INVENTION

Various methods of evaluation of potential future products and services as well as evaluation of existing groups of investments (an investment portfolio) have been used over the years to evaluate the performance of securities and other related investment resources. A company's disclosed financial data often serves as the principle basis for fundamental analysis, as taken from sources such as 10-Ks and 10-Qs, but these only begin to measure the true value of a possible investment. Missing in the evaluation are the resources, capabilities or inventions that perhaps a company desires to acquire when it seeks to invest in another company overall, or in specific products or services, so as to gain access to desired resources. Also, finer detail is lost in the most typical forms of analysis, not providing an investor with the granular details that they need to evaluate if a given potential investment meets their company's needs.

Further, there is a need for investors to quickly visualize how well a potential investment in a company, product or service meets their needs, without having to spend hours of complicated analysis of prepared documents and exploring each potential investment opportunity. However, this is difficult without losing the fine detail that a user may require in order to make an educated investment decision. Thus, there is a need for a system and method that evaluates the performance, capabilities, features and/or functionality of any category of investment such as a mutual fund, product or service, individually on its own, or specifically, as it relates to any type of investment portfolio. This entails use of financial, product or service data available for individual stocks, investment products or product/service details within the portfolio that enable better understanding and comparison. Also, there should be a means of letting users focus on the level of detail that they require at a given moment when trying to evaluate the best available investment opportunity to them. Lastly, users must have the option of selecting their own investment criteria and how important their criteria are relative to one another.

Therefore what is needed is an intuitive graphical representation of a potential investment opportunity that provides an easy means of viewing various levels of detail, that allows users to select their own investment evaluation criterion and to assign their own weights to these criteria to reflect the level of importance that they wish to assign to them.

### SUMMARY OF THE INVENTION

The instant invention, as illustrated herein, is clearly not anticipated, rendered obvious, or even present in any of the prior art mechanisms, either alone or in any combination thereof. A method of graphically representing business listings and evaluating investment portfolios designed to overcome the previously mentioned shortcomings would give users (users being defined as markers, vendors, administrators and generally as anyone making use of the instant invention for some purpose) a much more effective means of arriving at and making informed business decisions. Thus, the several embodiments of the instant invention are illustrated herein.

Therefore, it is an object of the present invention to overcome the previously mentioned shortcomings found in prior business evaluation methods and thus allow users to quickly visualize the elements of portfolio to determine quickly which potential investment represents a better match for said user's needs.

Another object of the present invention is to provide a graphical means of representing various stages or uses in evaluating an investment (from hereinafter referred to as arrays) as a high level of detail for user evaluation.

Another object of the present invention is to provide a graphical means of representing various focus areas used in evaluating an investment (from hereinafter referred to as threads) as a middle level of detail for user evaluation.

Another object of the present invention is to provide a graphical means of representing specific listings of capabilities, to enable tasks, goals, reporting and process completion (from herein after referred to as fibers), as a low level of detail for user evaluation.

It is another object of the present invention to represent arrays as figures around a central pivot point where each array is related to the following array in sequence when moving in a clockwise or counterclockwise direction (but maintaining one such direction for any given graphical portfolio representation).

It is another object of the present invention to represent arrays that are addressed by a given listing or portfolio by filling such arrays with a color.

It is another object of the present invention to determine if an array is colored or not in a dynamic analysis and updating fashion.

Another object of the present invention is to represent the various threads of a listing or portfolio by concentric rings of differing colors centered over the same pivot point being used by arrays.

Another object of the present invention is to represent the various threads of a listing in a logical order where the most micro-analytic threads are closest to the pivot point and the most macro-analytic threads are furthest from the pivot point.

Another object of the present invention is to present threads of different circumferences so that no thread overlaps another thread.

Another object of the present invention is to present threads of varying thicknesses to represent the user assigned importance of one thread in relation to other threads.

A further object of the present invention is to segment threads into various capabilities to graphically represent fibers.

A further object of the present invention is to use fibers with different lengths, relative sizes or coverage areas to represent the user assigned importance of one fiber in relation to the other fibers, within a thread.

A further object of the present invention is to leave uncolored fibers with the corresponding thread color, when the capability represented by the given fiber is not provided.

A further object of the present invention is to color threads or individual fibers a first distinct color when a given listing or portfolio does not address user requirements for a given thread or fiber.

Another object of the present invention is to color arrays, threads and fibers a second distinct color when one investment portfolio or listing provides excess coverage (coverage provided by another possible investment opportunity, existing portfolio coverage or coverage not required by a user at all).

Another object of the present invention is to allow a user to view arrays only, threads only, arrays and threads only, threads and fibers only or threads, arrays and fibers, depending on the level of detail that a users wants at a given moment.

Another object of the present invention is to calculate various evaluation scores by allowing the user to assign various weights to and among arrays, threads and fibers and then arrive at a relevance score by seeing the relative alignment that a given portfolio or listing provides given the user assigned weights.

Another object of the present invention is to allow for arrays, threads and fibers to rotate at varying speeds to represent the level of portfolio optimization that they provide, where the faster the rate of rotation the greater the level of optimization.

Another object of the present invention is to utilize computers to generate the graphical representations of the other objects of this invention.

These together with other objects of the invention, along with various features of novelty which characterize the invention, are pointed out with particularity in the claims and Detailed Description of the Embodiments Sections, and drawings of this application, with all of said sections also adding to this disclosure.

### BRIEF DESCRIPTION OF THE DRAWINGS

FIG. 1 illustrates one view of the present invention in which only arrays appropriate to the given portfolio are displayed around a central pivot point.

FIG. 2 illustrates a second view of the present invention in which only threads appropriate to the given portfolio are displayed. Displayed are seven threads of different diameters so that no thread would overlap another thread, should they all be placed around once center point.

FIG. 3 illustrates seven threads that have been segmented into five fibers within each thread.

FIG. 4 illustrates a view of the present invention in which a combination of arrays, threads and fibers are all visible with each other in the same figure all located around on central pivot point.

FIG. 5 illustrates a flow chart, listing steps that can be used to calculate a relevance score and the five steps it involves.

FIG. 6 illustrates a flow chart, listing steps that can be used to calculate a focus score and the five steps it involves. Note: this figure illustrates how a focus score is calculated after a user has already selected the number of number of arrays and threads to be used in the evaluation model and after relevance scores have already been calculated for the listings to be evaluated.

### DETAILED DESCRIPTION OF THE DISCLOSED EMBODIMENTS

The detailed description set forth below in connection with the appended drawings is intended as a description of presently preferred embodiments of the invention and does not represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention, such as graphical depictions of arrays, threads and fibers of varying shapes, colors, shades, patterns and dimensions in order to represent various groups of investments (herein also referred to as a portfolio) and various products and services (herein also referred to as a listing).

Presently, there are no visual means of evaluating multi-leveled business listing and/or investment portfolios that provide a user the ability to view the various elements of detail that the present invention provides. Previous attempts have failed to provide users with the ability to view all the information they need at a given moment in such an intuitive way.

The present invention solves all these shortcomings by introducing a graphical means of viewing arrays, threads and fibers along with a coloring, shading or varying-pattern scheme to provide information about each of these levels. In addition the present invention also provides users with additional information by also introducing circular movement among the various graphically depicted elements.

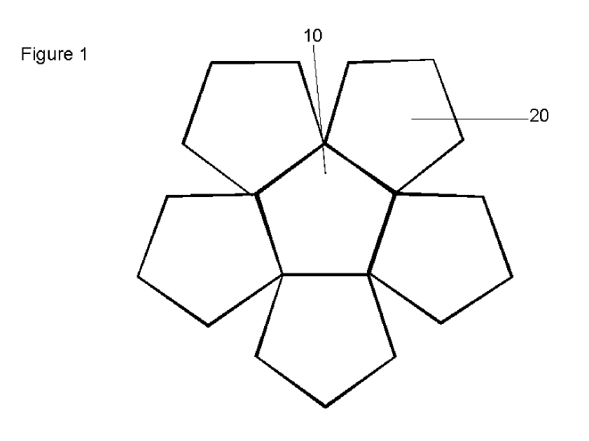

FIG. 1 shows a graphical depiction of five arrays 20 around one central point 10. The number of arrays will vary with the number of stages-of-use defined by the user (one array 20 per stage of use defined). The shape of the central pivot point 10 may vary but should be in relative proximity to the arrays 20 surrounding it. The arrays 20 may be colored, shaded or filled by a different pattern in order to convey different information to the user, such as if the portfolio, or listing being examined, addresses an individual array 20. Further, each array 20 may be labeled with the stage of use it represents (perhaps a manage and report array, a plan and budget array, and so on). Also, the arrangement of the arrays 20 may be in a logical order from left-to-right or right-to-left according to the relationship of one array 20 to its neighboring arrays 20. FIG. 1 also may serve as a demonstration of one embodiment of the invention where only the array level of the invention may be viewed at a time.

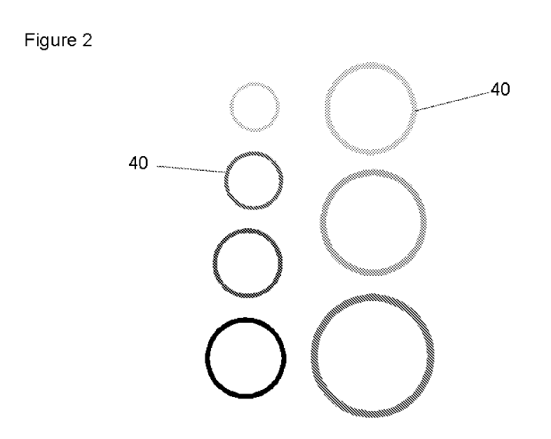

FIG. 2 shows a total of seven threads 40 visible, where each thread 40 represents a different focus area selected by the user. The thickness of each thread 40 may vary proportionately to the relative importance of that thread 40 to the other threads 40. However, the circumference of each thread 40 should vary so that when the threads 40 are placed inside of each other, no thread 40 should overlap any other thread 40. Each thread 40 should be distinguishable from the others visually, but use of varying colors, shades and or patterns imprinted within it. The individual threads 40 themselves may be filled by a distinguishing outline color, area color, shade or pattern in order to represent different information to the user, such as: overlapping coverage from a alternative investment portfolio, lack of coverage, to highlight recommendations to the user, or other potentially useful user information. The threads 40 may be ordered in a logical fashion, such as putting threads 40 that deal with the most micro-centric matter at the center, to the most macro-centric matter on the largest (outermost) thread 40. FIG. 2 also demonstrates the embodiment of the invention in which a user may only view the thread level alone at a given time.

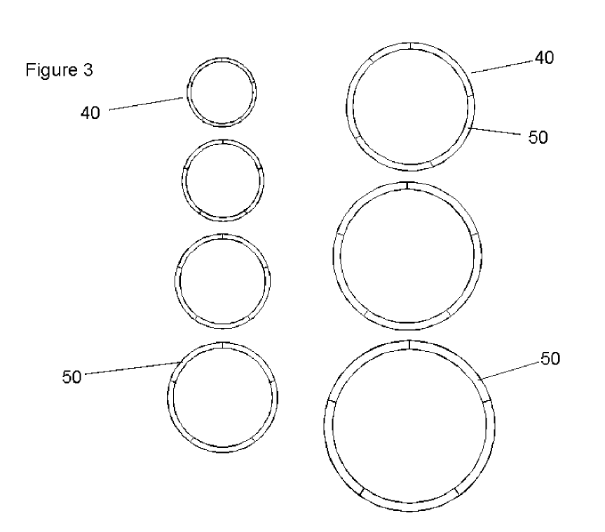

FIG. 3 depicts seven threads 40 having been segmented into five fibers 50 each of which represent various capabilities within its given thread 40. The relative length of each fiber 50 segment may vary depending upon the relative importance of that fiber 50 in comparison to the other fibers 50 (as assigned by the user). Fibers 50 are distinguishable from one another by the use of a boarder comprised of differing colors, patterns or shades. The individual fibers 50 themselves may be filled by a distinguishing color, shade or pattern to represent different information to the user, such as overlapping coverage from a alternative investment portfolio, lack of coverage, recommendations to the user, or other potentially useful user information. FIG. 3 also demonstrates an embodiment of the invention in which a user may only view the thread-fiber level alone at a given time.

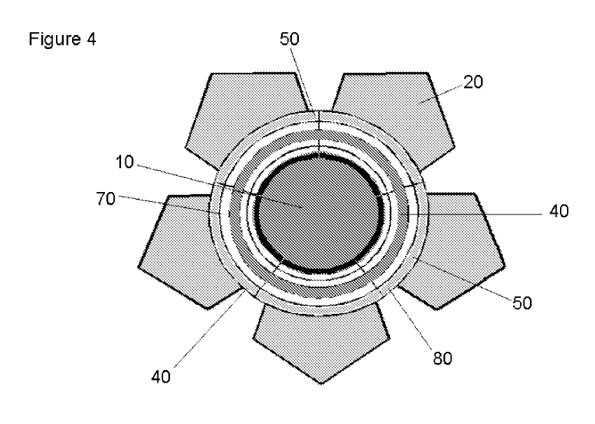

FIG. 4 illustrates a combined view of the arrays 20, threads 40 and fibers 50 all in a single unified view. All three layers are located around one central pivot point 10. All the properties of the arrays 20, threads 40, and fibers 50 mentioned in the preceding paragraphs are all preserved, however, it should be noted that the thread or thread-fiber layers should not obscure the view of the array layer. It should also be noted that the array layer may be viewed with the thread layer, without a thread-fiber layer.

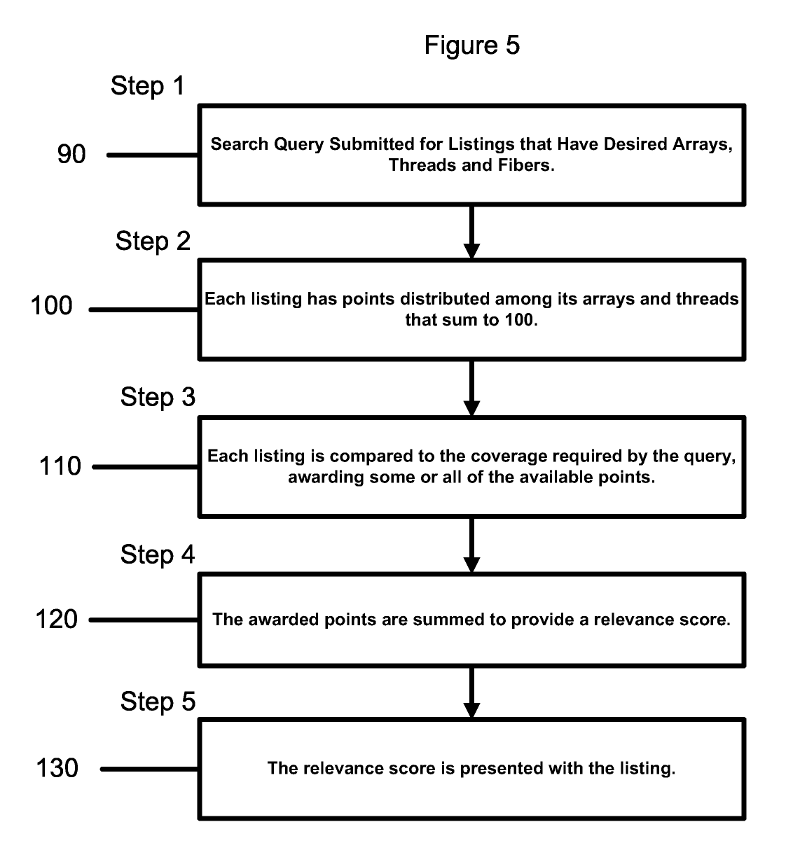

FIG. 5 illustrates “relevance steps” that may be taken to calculate a relevance score. Relevance step 1 90 demonstrates that first a user submits a search query to find listings that have all the desired arrays, threads and fibers that a user requires to be addressed in a listing. Relevance step 2 100 points out that 100 total relevance points are divided into the various arrays and threads contained in the listing. Relevance step 3 110 entails determining if the listing provides adequate coverage for the arrays and threads being evaluated. If it is determined that the listing does provide adequate coverage, then the points assigned to that weight or thread will be allocated to that listings relevance score. Relevance step 4 120 points to the summing of all the awarded relevance points for the areas of adequate array and thread coverage for that listing. Finally, Relevance step 5 130 points to the presentation of the listing and its newly calculated relevance score.

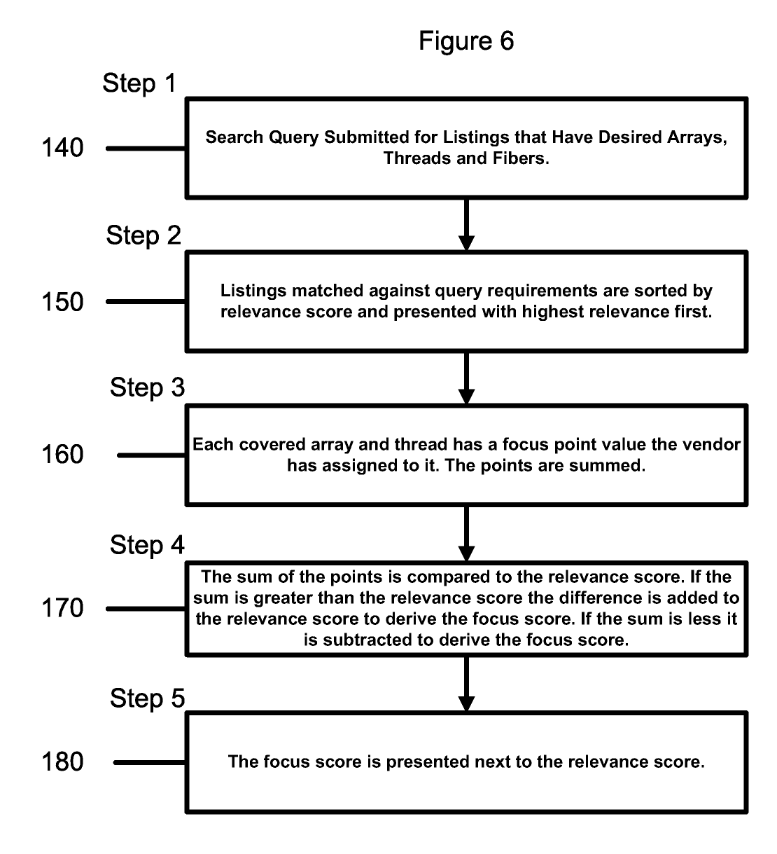

FIG. 6 illustrates “focus steps” that may be taken to calculate a focus score, once a relevance score has already been calculated. Focus step 1 140 demonstrates that first a user submits a search query to find listings that have all the desired arrays, threads and fibers that a user requires to be addressed in a listing. Focus step 2 150 sorts listings that were matched against query requirements by their relevance scores (highest scores first). In focus step 3 160 each thread and fiber has a focus value assigned to it by the user. Upon determining that one of these thread or fiber areas has adequate coverage for that area, the focus points assigned by the user for that area are then added to that listings preliminary focus score. The total preliminary focus score is then calculated from the sum of all the points awarded for each area with adequate coverage. If it is determined that the listing does provide adequate coverage, then the points assigned to that weight or thread will be given to that listings relevance score. Focus step 4 170 compares the preliminary focus score to the previously calculated relevance score for the current listing being evaluated. In situations in which the sum of the preliminary focus score is greater than the relevance score, the difference between these two scores is added to the calculated relevance score to yield the final focus score. However, in situations in which the preliminary focus score is less then the previously calculated relevance, score the difference between these is subtracted from the calculated relevance score to find the final focus score. Finally focus step 5 180 points to the presentation of the listing and its newly calculated focus score next to its relevance score.

Information regarding the relevance, focus and other related evaluation metrics, efficiency, effectiveness and optimization of a portfolio or listing may be calculated using various algorithms by evaluating how well arrays, threads and fibers meet the investment needs of a given user. The steps illustrated in FIGS. 5 and 6 list only one embodiment to arrive at their respective relevance and focus metrics, and do not limit this invention to other potential methods of arriving at these or other metrics used to evaluate a listing. In addition, this information may also be graphically depicted by allowing arrays and/or threads to rotate in a clockwise motion about the central pivot point, wherein the greater the speed of the rotation the greater the relevance, efficiency, effectiveness and/or optimization of the given arrays or threads rotating.

By utilizing the calculated information regarding relevance, efficiency, effectiveness and optimization of a portfolio or listing (with special attention paid to efficiency and effectiveness) this modeling method may graphically depict fiber level investment recommendations. By using calculated efficiency and effectiveness scores, recommended fibers may be graphically “highlighted by using a select color, shade or pattern for easy user visual recognition.

In other embodiments of this invention the dimensions, shapes, colors, shades and patterns used in the various layers, or in the borders between them may vary as well as the speeds by which any individual elements may rotate in a clockwise or counter-clockwise direction. These embodiments may be graphically generated by hand or machine, and may be viewed in hard copies such as on paper, or may be electronically generated by a computer and displayed on a monitor, projector or other type of viewing device.

What is claimed is:

1. A multi-leveled graphical representation business listing and investment portfolio evaluation method comprising a step of graphically representing various stages of use associated with various portfolios and listings using at least one array centered around a pivot point.

2. The multi-leveled graphical representation business listing and investment portfolio evaluation method of claim 1, further comprising using colors within said at least one array to represent information that can be graphically conveyed to a user.

3. The multi-leveled graphical representation business listing and investment portfolio evaluation method of claim 2, further comprising using shades within said at least one array to represent information that can be graphically conveyed to a user.

4. The multi-leveled graphical representation business listing and investment portfolio evaluation method of claim 3, further comprising using various patterns within said at least one array to represent information that can be graphically conveyed to a user.

5. The multi-leveled graphical representation business listing and investment portfolio evaluation method of claim 4, further comprising using a combination of at least one member of the group comprised of colors, shades or patterns within said at least one array to represent information that can be graphically conveyed to a user and further comprises the step of calculating evaluation scores.

6. The multi-leveled graphical representation business listing and investment portfolio evaluation method of claim 5, further comprising the step of graphically depicting movement of said at least one array to represent information to a user, wherein said movement comprises:
circular clockwise or counter-clockwise movement of said at least one array about said pivot point, or
clockwise or counter-clockwise movement of said at least one array, each rotating about an axis of rotation while still located about said central pivot point, or
both circular clockwise or counter-clockwise movement of said at least one array about said pivot point and about an axis while still located about said central pivot point.

7. A multi-leveled graphical representation business listing and investment portfolio evaluation method comprising a step of graphically representing various focus areas associated with various portfolios and listings using at least one thread optionally centered around a pivot point.

8. The multi-leveled graphical representation business listing and investment portfolio evaluation method of claim 7, further comprising using outline colors or colors within said at least one thread to represent information that can be graphically conveyed to a user.

9. The multi-leveled graphical representation business listing and investment portfolio evaluation method of claim 8, further comprising using shades within said one at least one thread to represent information that can be graphically conveyed to a user.

10. The multi-leveled graphical representation business listing and investment portfolio evaluation method of claim 9, further comprising using various patterns within said at least one thread to represent information that can be graphically conveyed to a user.

11. The multi-leveled graphical representation business listing and investment portfolio evaluation method of claim 10, further comprising using a combination of at least one member of the group comprised of outlines, colors, shades and patterns within said at least one array to represent information that can be graphically conveyed to a user.

12. The multi-leveled graphical representation business listing and investment portfolio evaluation method of claim 11, step further comprising segmenting at least one of said at least one thread into at least one fiber to represent the capabilities of said listing.

13. The multi-leveled graphical representation business listing and investment portfolio evaluation method of claim 12, wherein said step further comprises using a combination of at least one member of the group comprised of colors, shades and patterns within said at least one fiber to represent information that can be graphically conveyed to a user and further comprises optionally comprising the step of calculating evaluation scores.

14. The multi-leveled graphical representation business listing and investment portfolio evaluation method of claim 13, further comprising the step of graphically depicting movement of said at least one thread to represent information to a user, wherein said movement comprises clockwise or counter clockwise movement of said threads about said central pivot point.

15. A multi-leveled graphical representation business listing and investment portfolio evaluation method comprising a step of graphically representing one or more levels of detail using one or more of a combination of the group selected from the group consisting of at least one array, at least one thread and at least one thread with at least one fiber, all optionally centered around a pivot point wherein the information being represented by said at least one array, is the various stages of use of a listing or portfolio, the information conveyed by said at least one thread is relates to various focus areas associated with various portfolios and listings and the information associated with said at least one fiber relates to the capabilities of various listings.

16. The multi-leveled graphical representation business listing and investment portfolio evaluation method of claim 15, further comprising using various colors within at least one member of said group consisting of said at least one array and said at least one thread and said at least one fiber to represent information that can be graphically conveyed to a user.

17. The multi-leveled graphical representation business listing and investment portfolio evaluation method of claim 16, further comprising using various shades within at least one member of said group consisting of said at least one array, said at least one thread and said at least one fiber to represent information that can be graphically conveyed to a user.

18. The multi-leveled graphical representation business listing and investment portfolio evaluation method of claim 17, further comprising using various patterns within at least one member of said group consisting of said at least one array, said at least one thread and said at least one fiber to represent information that can be graphically conveyed to a user.

19. The multi-leveled graphical representation business listing and investment portfolio evaluation method of claim 18, further comprising using a combination of at least one member of a group consisting of colors, shades and patterns within at least one member of said group consisting of said at least one array, said at least one thread and said at least one fiber to represent information that can be graphically conveyed to a user and further comprises the step of calculating an evaluation score.

20. The multi-leveled graphical representation business listing and investment portfolio evaluation method of claim 19, further comprising the step of graphically depicting movement of said at least one thread and at least one array to represent information to a user, wherein said thread movement comprises clockwise or counter clockwise movement of said at least one thread about said central pivot point and the movement of at least one array comprises:
circular clockwise or counter-clockwise movement of said at least one array about said pivot point, or
clockwise or counter-clockwise movement of said at least one arrays, each rotating about an axis of rotation while still located about said central pivot point, or
both circular clockwise or counter-clockwise movement of said at least one array about said pivot point and about an axis while still located about said central pivot point.
